(19) United States
(12) Patent Application Publication
(10) Pub. No.: US 2002/0055894 A1
(43) Pub. Date: May 9, 2002

(54) Internet contextual search engine-based sales commission system

(76) Inventor: Andrew D. Hyder, Minneapolis, MN (US)

Correspondence Address: SKINNER & ASSOCIATES, 619 SECOND STREET, SUITE 201, HUDSON, WI, 54016, US

(21) Appl. No.: 09/796,315

(22) Filed: Feb. 28, 2001

Related U.S. Application Data
(60) Provisional application No. 60/185,615, filed on Feb. 29, 2000.

(51) Int. Cl. G06F 17/60; G06F 15/173

(52) U.S. Cl. 705/30; 709/224

(57) ABSTRACT

An Internet contextual search engine-based sales commission system, comprising a global search engine based affiliate network including a dialogue-driven search engine, wherein users of the at least one affiliate are presented with a dialogue box with preloaded text that is relevant to the content of a corresponding web site for the at least one affiliate; and a performance-based tracking and reporting system adapted for identifying actual sales and providing a credit to the affiliate that referred a buying user to the retailer. A method of generating qualified buyers for a retail web site, comprising the steps of installing a performance-based tracking and reporting system on a retail web site, and providing a dialogue-driven search engine on at least one affiliate web site, the dialogue-driven search engine providing a potential buyer with a dialogue box with preloaded text that is relevant to the content of each the affiliate web site, wherein dialogue box input from the potential buyer determines if the potential buyer is a qualified buyer.

### BACKGROUND OF THE INVENTION

1. Field of the Invention

The present invention relates, generally, to electronic commerce. More particularly, the invention relates to an Internet contextual search engine-based sales commission system and a method of generating qualified buyers for a retail web site.

2. Background Information

The state of the art includes various devices and methods for generating buyers for e-commerce retailers.

Known systems and methods are believed to have significant limitations and shortcomings.

The present invention provides an Internet contextual search engine-based sales commission system and a method of generating qualified buyers for a retail web site which is believed to constitute an improvement over the known art.

### BRIEF SUMMARY OF THE INVENTION

The present invention provides an Internet contextual search engine-based sales commission system, comprising a global search engine based affiliate network including a dialogue-driven search engine, wherein users of the at least one affiliate are presented with a dialogue box with preloaded text that is relevant to the content of a corresponding web site for the at least one affiliate; and a performance-based tracking and reporting system adapted for identifying actual sales and providing a credit to the affiliate that referred a buying user to the retailer.

The invention further provides a method of generating qualified buyers for a retail web site, comprising the steps of installing a performance-based tracking and reporting system on a retail web site, and providing a dialogue-driven search engine on at least one affiliate web site, the dialogue-driven search engine providing a potential buyer with a dialogue box with preloaded text that is relevant to the content of each the affiliate web site, wherein dialogue box input from the potential buyer determines if the potential buyer is a qualified buyer.

The features, benefits and objects of this invention will become clear to those skilled in the art by reference to the following description, claim(s), if any, and drawings.

### DETAILED DESCRIPTION

Referring to Appendix A and B, an example of the preferred embodiment of the present invention is illustrated.

The invention includes an Internet contextual search engine-based sales commission system, comprising a global search engine based affiliate network including a dialogue-driven search engine, wherein users of the at least one affiliate are presented with a dialogue box with preloaded text that is relevant to the content of a corresponding web site for the at least one affiliate; and a performance-based tracking and reporting system adapted for identifying actual sales and providing a credit to the affiliate that referred a buying user to the retailer.

The invention further includes a method of generating qualified buyers for a retail web site, comprising the steps of installing a performance-based tracking and reporting system on a retail web site, and providing a dialogue-driven search engine on at least one affiliate web site, the dialogue-driven search engine providing a potential buyer with a dialogue box with preloaded text that is relevant to the content of each the affiliate web site, wherein dialogue box input from the potential buyer determines if the potential buyer is a qualified buyer.

Appendix A (9 pages) is product literature disclosing the e-commerce strategy and solution for the present invention.

Appendix B (10 pages) are printouts from the Web Site of PageLab Network, Inc. and include information about the Company, the Products and/or services of the company (MEGAaffiliate™ and CannedProfit™), and the Industry.

I. Introduction to Subjex Dialogue Engine

Description of Subjex

Subjex is an artificial intelligence software system that conducts dialogue with users (through text) to dynamically refine searches with normal humanlike conversation. Instead of millions of results, Subjex provides a few extremely accurate results.

In the June, 2000 Forrester report “Must Search Stink?”, 90% of the businesses surveyed, rate searches as very or extremely important. 93% of these businesses do not offer keyword search or had search engines that failed basic tasks.

Subjex has three features that no other search engine has:

1) Subjex uses artificial intelligence to conduct dialogue with the user;

2) Subjex uses its proprietary matrix algorithm to determine the number and type of searches needed to find the answer;

3) Subjex uses its proprietary methodology to prioritize the search results based on “tightness of fit” not location or frequency or popularity of keywords.

Subjex technology base:

The Subjex proprietary Artificial Intelligence software is written in the JAVA language, which was tailor-made for the distributed, client-server environment of the Internet. Developer Sun Microsystems terms it “Write once, run anywhere”, platform-independent interactive computing. It's a highly scalable, robust, object-oriented, multi-threaded, dynamic general-purpose, unicode capable programming language that was designed to implement a network environment from the beginning.

Subjex interacts with a customer's database in Oracle, MySQL, and other formats, as well as text files such as HTML, and ASCII text. In addition, customized conversions may include such popular formats as Adobe Acrobat© PDF files and Microsoft© Word documents.

Data Flow overview

1. User enters a query in a natural language question such as “What clothing is approved by OSHA?”.

2. Subjex does a preliminary search and gathers intelligence from the results. From this intelligence, it discerns the potential next logical step a user may wish to take in the interaction with Subjex. The result is dialogue sent back to the user in the form of a few links as well as question(s) to further refine the users needs.

“There are over 20 thousand web pages about what clothing is approved by OSHA”.

Should I look for OSHA Releases or something else?

3. Subjex “maintains state” between iterations of dialogue. In other words, it remembers the context of each conversation until the user changes the subject by clicking on the reset link.

II. Natural Frame Dialogue as currently used by Subjex

Overview of Natural Frame Dialogue:

Natural Frame Dialogue goes beyond the scope of natural language, in that it encompasses true two-way dialogue instead of simply one-way communication.

Natural Frame Dialogue may be thought of as maintaining a “Frame of Mind”. For example; if a person uses the acronym “RAD”, it may be interpreted with various results depending on the frame of mind of the listener. In the frame of mind of a teenager, it may be interpreted to mean “Radical”, or cool or something similar. To the JAVA or applications programmer, it more likely would be interpreted as “Rapid Access Development”, a term common among programmers.

Diagram view as used on Subjex.com Web site:

[chemical structure]

III. Licensing of Subjex Natural Frame Dialogue

Subjex offers licensing opportunities for corporate entities. The power of Natural Frame Dialogue may be put to use with the following advantages over traditional search methodologies:

Faster results. By reducing the number of results through which to qualify from potentially several thousand to a handful of highly qualified links, expected results can be up to an order of magnitude faster.

More accurate search results. Each result set is fine-tuned to the user's specific question, with no superfluous clutter.

Increased productivity. Reduced search time results in more time available for applying the results.

Increased customer and employee satisfaction. Users report less time spent searching, resulting in lower frustration.

Reduced learning curve. Users have no need to learn Boolean search phrasing, and as long as they know the English language, they know all they need to know for a Subjex search.

Natural interface with true dialogue. Natural Frame Dialogue emulates the dialogue people experience naturally in every day life.

Enhances existing search engines. The Subjex Dialogue Engine can act as an interface between an existing search engine and end users. This allows the user to access the ease of making a request in Natural Language while retaining the Boolean search logic of existing search engines.

Corporate Licensing Overview

Subjex offers several products for licensing to public and private corporate sectors including government. These products use the base search engine as the foundation from which to expand. The base search engine works in conjunction with the other products to deliver Natural Frame Dialogue with the user.

Additional products/options enable the licensee to customize the application to their specific needs, enabling the customer to employ an industry or organization specific solution to existing individual challenges.

| PRODUCT/OPTIONS | DESCRIPTION |
|---|---|
| Base Search Engine | The Subjex Natural Frame Dialogue technology |
| | hosted on our server. |
| Customer Data Base | Includes searchable HTML or text files |
| | available via the Internet. This can be done via |
| | standard or secure connections in a variety of |
| | formats. |
| Standard Internet Search | Encompasses Internet Search Engine databases |
| | Subjex normally searched by Subjex. Included |
| | are: Google, AltaVista, NorthernLight, and |
| | Webcrawler. |
| Internet Exclusions | This option filters out results from specifically |
| | chosen web sites, such as competitors or sites |
| | chosen that do not align with customer's |
| | values. (Subjex already imposes limits on Porn |
| | and Illegal sites.) |
| Selected Internet | Specific Internet databases or Search Engines |
| Databases | that the customer wishes to search. These may |
| | be stand alone or in addition to the Standard |
| | Internet Search. |
| Custom Frame | This entails building a custom frame which is |
| | geared towards a customer's individual and |
| | unique needs. This includes the usage of |
| | specific acronyms, synonyms and unique and |
| | common questions. |
| Interface to existing | In this instance, Subjex would act only as the |
| Search Engines | interface to existing Boolean search engines |
| | without replacing the search engine itself. This |
| | approach takes full advantage of the power of |
| | these other search engines while adding the |
| | ability to easily interface with the end user. |

IV. PRNN Enhanced Licensing

PRNN Overview:

PRNN (Progressive Refinement Neural Network) is the extension of the Neural Network approach to Artificial Intelligence for enhancement of the Natural Frame Dialogue that is used by the Subjex search engine.

Progressive Refinement is the next order of successive refinement, which not only learns from past experience, but applies this intelligence to actually help predict the next step in dialogue.

As a base from which to fully understand the implications of the PRNN approach, consider that our proprietary interpretation of Neural Network application is based loosely on Radial Basis Function Networks found within traditionally viewed Supervised Neural Networks.

Basically, PRNN employs a hidden layer between user input and dialogue output. Within this hidden layer lies value weighted data that is applied to the original input in an attempt to anticipate the needs of the user. This hidden layer is generated and updated as a direct result of analysis of previous conversations, thus giving the Subjex licensee the advantage of continual learning and Progressive Refinement of dialogue.

PRNN is designed to be used in conjunction with a specific Frame as the dialogue is extremely context specific and may apply to a relatively narrow scope.

[image]

V. Security options of Licensing

SSL Option with Encryption:

This option utilizes Secure Socket Layers (SSL) with a security certificate that uses 128-bit strong encryption. While SSL is used primarily for financial transactions, licensees may require the use of SSL for their searches. (Please note: due to export restrictions, 128-bit encryption may only be used within the United States; for licensees outside of the U.S., 40-bit encryption would be required for SSL support.)

Dedicated Server:

As a further measure of security, a dedicated server may be implemented. This would include both database (MySQL) and web server (Apache) residing on a dedicated machine to be used only by the licensee.

In this instance, this machine would only be accessible by our technical staff and those users that the licensee would desire to provide access. All other access would be restricted, either by IP, by a secure login, or by a secure certificate. We will work with the licensee to provide the best security model for their needs.

[image]

[image]

In order to successfully develop a customized Frame, it is necessary for the licensee to become involved in certain elements of development. Involvement takes place in the form of interviews, data structure analysis, and questionnaires. The process of developing a Frame is iterative, and may span a number of sessions. The following bullet points are presented as a starting point for the definition of a custom Frame.

Basic Project Management requirements to include:

Identification of Customer Point of Contact.

Definition of Customer expectations

Declaration of deliverables.

Measurement of success/failure of deliverables.

Document of Project Scope.

Documentation of timeline.

Definition of change order procedure.

Other standard Project Management documentation.

In addition to the standard requirements listed above, Subjex will be in need of the following information from the Licensee to be used in the creation of the custom Frame:

A listing of frame specific acronyms.

A listing of frame specific synonyms

A listing of frame specific Homonyms

A listing of frame specific commonly misspelled words and the common misspellings.

A listing of typical anticipated questions along with appropriate responses.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. An Internet contextual search engine-based sales commission system, comprising:
(a) a global search engine based affiliate network including a dialogue-driven search engine, wherein users of said at least one affiliate are presented with a dialogue box with preloaded text that is relevant to the content of a corresponding web site for said at least one affiliate; and
(b) a performance-based tracking and reporting system adapted for identifying actual sales and providing a credit to said affiliate that referred a buying user to said retailer.

2. The Internet contextual search engine-based sales commission system of claim 1, further comprising a performance-based search engine positioning system adapted for introducing and maintaining a predetermined ranking in predetermined search engines.

3. The Internet contextual search engine-based sales commission system of claim 2, wherein said performance-based search engine positioning system includes a tracking and reporting feature.

4. The Internet contextual search engine-based sales commission system of claim 3, further comprising a pricing mechanism for said performance-based search engine position system wherein said retailer is charged only for days when said predetermined ranking is achieved for a corresponding keyword phrase.

5. A method of generating qualified buyers for a retail web site, comprising the steps of:
(a) installing a performance-based tracking and reporting system on a retail web site;
(b) providing a dialogue-driven search engine on at least one affiliate web site, said dialogue-driven search engine providing a potential buyer with a dialogue box with preloaded text that is relevant to the content of each said affiliate web site, wherein dialogue box input from said potential buyer determines if said potential buyer is a qualified buyer.

6. The method of generating qualified buyers for a retail web site of claim 5, further comprising the steps of tracking and reporting sales history.

7. The method of generating qualified buyers for a retail web site of claim 5, further comprising the step of positioning and maintaining said retail web site in a predetermined ranking for predetermined search engines.
